(19) United States
(12) Patent Application Publication
(10) Pub. No.: US 2014/0198213 A1
(43) Pub. Date: Jul. 17, 2014

(54) IMAGING SYSTEM AND METHOD FOR DETECTING FOG CONDITIONS

(71) Applicant: Gentex Corporation, Zeeland, MI (US)

(72) Inventors: Peter A. Liken, West Olive, MI (US); Phillip R. Pierce, Grand Rapids, MI (US)

(73) Assignee: Gentex Corporation, Zeeland, MI (US)

(21) Appl. No.: 14/156,031

(22) Filed: Jan. 15, 2014

Related U.S. Application Data
(60) Provisional application No. 61/752,590, filed on Jan. 15, 2013.

(51) Int. Cl. G06K 9/00; B60Q 1/00; H04N 7/18

(52) U.S. Cl. CPC G06K 9/00791; H04N 7/183; B60Q 1/0023
USPC 348/148

(57) ABSTRACT

An imaging system and method is provided for detecting fog conditions surrounding a controlled vehicle. An imager having an image sensor is configured to image a scene external and forward of the controlled vehicle and to generate image data corresponding to the acquired images. A processor is configured to receive the image data and to receive additional information including at least one of an outside temperature, a windshield wiper speed, and a vehicle speed. The processor selects logic and/or parameters for detecting the presence of fog in response to the received additional information. The processor then analyzes the image data using the selected logic and/or parameters to detect the presence of fog and generates a signal responsive to the detection of fog.

### CROSS-REFERENCE TO RELATED APPLICATION

This application claims priority to and the benefit under 35 U.S.C. §119(e) of U.S. Provisional Patent Application No. 61/752,590, filed on Jan. 15, 2013, entitled “SYSTEM AND METHOD FOR CONTROLLING VEHICLE EQUIPMENT IN FOG CONDITIONS,” the entire disclosure of which is hereby incorporated herein by reference.

### FIELD OF THE INVENTION

The present invention generally relates to an imaging system and method for use in a controlled vehicle, and more specifically relates to an imaging system and method with improved features for detecting fog conditions and automatically responding to detected fog conditions.

### SUMMARY OF THE INVENTION

According to one aspect of the present invention, an imaging system is provided for detecting fog conditions surrounding a controlled vehicle. The system includes an imager having an image sensor configured to image a scene external and forward of the controlled vehicle and to generate image data corresponding to the acquired images, and a processor. The processor is configured to: receive the image data; receive additional information including at least one of an outside temperature, a windshield wiper speed, and a vehicle speed; select logic and/or parameters for detecting the presence of fog in response to the received additional information; analyze the image data using the selected logic and/or parameters to detect the presence of fog; and generate a signal responsive to the detection of fog.

According to another aspect of the present invention, a method is provided for detecting fog conditions surrounding a controlled vehicle. The method includes the steps of: imaging a scene external and forward of the controlled vehicle and generating image data corresponding to the acquired images; receiving additional information including at least one of an outside temperature, a windshield wiper speed, and a vehicle speed; selecting logic and/or parameters for detecting the presence of fog in response to the received additional information; analyzing the image data using the selected logic and/or parameters to detect the presence of fog; and generating a signal responsive to the detection of fog.

According to another aspect of the present invention, a non-transitory computer readable medium is provided having stored thereon software instructions executed by a processor. The software instructions include the steps of: imaging a scene external and forward of the controlled vehicle and generating image data corresponding to the acquired images; imaging a scene external and forward of the controlled vehicle and generating image data corresponding to the acquired images; receiving additional information including at least one of an outside temperature, a windshield wiper speed, and a vehicle speed; selecting logic and/or parameters for detecting the presence of fog in response to the received additional information; analyzing the image data using the selected logic and/or parameters to detect the presence of fog; and generating a signal responsive to the detection of fog.

These and other features, advantages, and objects of the present invention will be further understood and appreciated by those skilled in the art by reference to the following specification, claims, and appended drawings.

### BRIEF DESCRIPTION OF THE DRAWINGS

The present invention will be more fully understood from the detailed description and the accompanying drawings, wherein:

FIG. 1 is a block diagram of an imaging system constructed according to an embodiment of the present invention;

FIG. 2 is a partial cross section of a rearview mirror assembly incorporating an imaging system according to another embodiment of the present invention; and

FIG. 3 is a flowchart illustrating an imaging method executed by a controller of the imaging system.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The embodiments generally relate to an imaging system with improved features to detect fog conditions and automatically respond to detected fog conditions. Some of the embodiments described herein relate to an imaging system capable of controlling exterior lights (as the vehicle equipment) of a controlled vehicle in response to image data acquired from an imager configured to capture images forward of the vehicle. Auto High Beam (AHB) and alternate methods of controlling the light beam illumination in front of a motor vehicle maximizes the use of high beams at night by identifying oncoming and preceding vehicles and automatically controlling the high beam lighting pattern. This prevents glare to other vehicles, yet maintains a high beam light distribution to illuminate areas not occupied by other vehicles. Prior imaging systems are known for controlling exterior vehicle lights in response to images captured forward of the vehicle. In these prior imaging systems, a controller would analyze the captured images and determine if any preceding or oncoming vehicles were present in a glare area in front of the vehicle employing the system. This “glare area” was the area in which the exterior lights would cause excessive glare to a driver if the exterior lights were in a high beam state (or some state other than a low beam state). If a vehicle was present in the glare area, the controller would respond by changing the state of the exterior lights so as to not cause glare for the other driver(s). Glare to other drivers can be prevented by moving a blocking mechanism in the high beam headlamps that blocks portions of the light otherwise generated by the headlamps from projecting in selected glare-free regions of the forward scene. Examples of such imaging systems are described in U.S. Pat. Nos. 5,837,994, 5,990,469, 6,008,486, 6,049,171, 6,130,421, 6,130,448, 6,166,698, 6,255,639, 6,379,013, 6,403,942, 6,587,573, 6,593,698, 6,611,610, 6,631,316, 6,653,614, 6,728,393, 6,774,988, 6,861,809, 6,906,467, 6,947,577, 7,321,112, 7,417,221, 7,565,006, 7,567,291, 7,653,215, 7,683,326, 7,881,839, 8,045,760, and 8,120,652, as well as in U.S. patent application Ser. No. 13/432,250 entitled “VEHICULAR IMAGING SYSTEM AND METHOD FOR DETERMINING ROADWAY WIDTH” and filed on Mar. 28, 2012, by Jeremy A. Schut et al., the entire disclosures of which are incorporated herein by reference.

Prior imaging systems that detect fog based on analysis of acquired images use one set of parameters or logic for fog detection that covered various weather conditions. As a result, prior imaging systems can have difficulty differentiating fog from snow reflections in the winter. Furthermore, when prior imaging systems use only one set of parameters or logic to compensate for various weather conditions, the system performance can be compromised. Examples of imaging systems that detect fog can be found in U.S. Pat. Nos. 6,254,259 and 8,045,760, the entire disclosures of which are incorporated herein by reference.

The embodiments described herein improve performance by acquiring image data and also receiving information such as, but not limited to, outside temperature, which may be received by a controller over the vehicle communication bus or a dedicated line, and adjusting the logic and parameters to best match the outside conditions. The controller can automatically select the logic and parameters based on predicted fog conditions. The controller can also adjust sensitivity to detected fog based on the received outside temperature and other inputs, such as windshield wiper speed and vehicle speed. For example the controller may adjust the sensitivity to detected fog by being more sensitive when the outside temperature represents a warm temperature (e.g. a summer temperature) and less sensitive when the outside temperature represents a cold temperature (e.g. temperatures at which snow may be present).

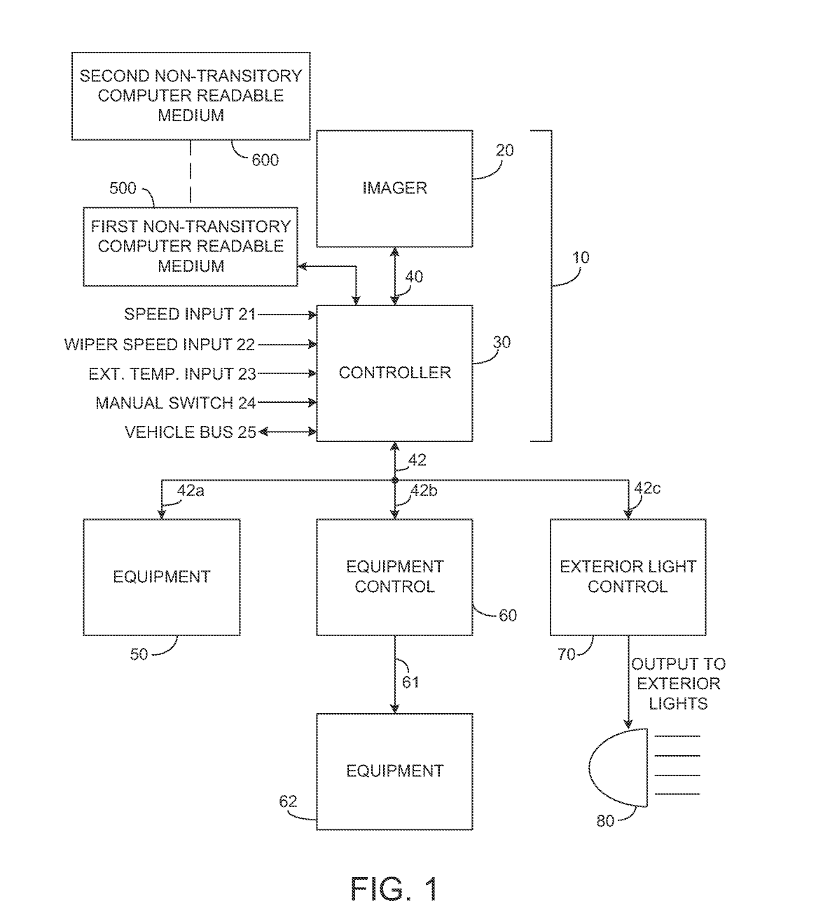

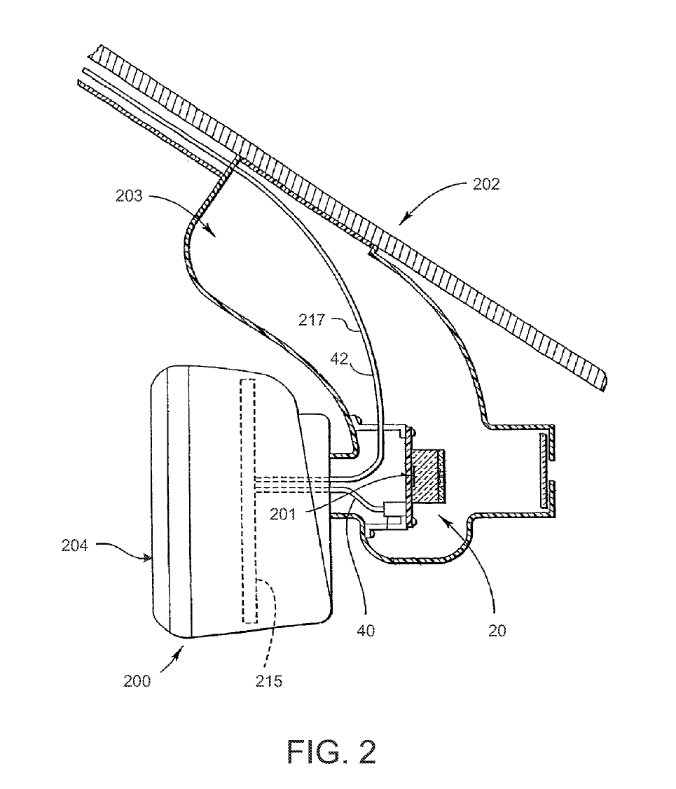

A first embodiment of an imaging system 10 is shown in FIG. 1 and includes an imager 20 and a controller 30. Imager 20 includes an image sensor (201, FIG. 2) that is configured to image a scene external and forward of the controlled vehicle and to generate image data corresponding to the acquired images. Controller 30 is configured to receive the image data and receive additional information including at least one of an outside temperature, a windshield wiper speed, and a vehicle speed. Controller 30 selects logic and parameters for detecting the presence of fog in response to the received additional information. Controller 30 then analyzes the image data using the selected logic and parameters to detect the presence of fog and generates a signal responsive to the detection of fog that can be used to control vehicle equipment, shown in FIG. 1 as equipment 50, 62, 80.

Controller 30 may be configured to directly connect to equipment 50 such that the generated signals directly control the equipment. Alternatively, controller 30 may be configured to connect to equipment control 60 and/or 70, which, in turn, is connected to the equipment being controlled 62 and 80, respectively, such that the signals generated by controller 30 only indirectly control the equipment. For example, in the case of the equipment being exterior lights 80, controller 30 may analyze the image data from imager 20 so as to generate signals that are more of a recommendation for an exterior light control 70 to use when controlling exterior lights 80. The signals may further include not just a recommendation, but also a code representing a reason for the recommendation so that equipment controls 60 and/or 70 may determine whether or not to override a recommendation. Further, as described in detail below, the signal may include an indication of the detection of fog conditions. Such a fog condition indication is particularly useful when an equipment control (e.g. 60 and/or 70) that is separate from controller 30 performs the direct control of the equipment. Alternatively, the detection of fog may be used by controller 30 in determining what recommendation to make.

By providing a fog condition indication, controller 30 provides additional information to exterior light control 70 and/or equipment control 60 that allows the vehicle manufacturer more flexibility in how they choose to respond to the fog condition indication, examples of which are to turn the high beam lighting off and/or turn fog lights on.

As shown in FIG. 1, various inputs, shown as inputs 21-24 may be provided to controller 30 that may be taken into account in forming a recommendation or a direct control signal. In some cases, such inputs may instead be provided to equipment control 60 and/or 70. For example, input from manual switch 24 may be provided to equipment control 60 and/or 70, which may allow equipment control 60 and/or 70 to override a recommendation from controller 30. It will be appreciated that various levels of interaction and cooperation between controller 30 and equipment controls 60 and 70 may exist. One reason for separating control functions is to allow imager 20 to be located in the best location in the vehicle for obtaining images, which may be a distance from the equipment to be controlled and to allow communication over the vehicle bus 25.

According to one embodiment, the imaging system 10 may be used to control one or more exterior lights 80 and the signal generated by controller 30 may be an exterior light control signal. In this embodiment, exterior lights 80 may be controlled directly by controller 30 or by an exterior light control 70, which receives a signal from controller 30 that serves as a recommendation. As used herein, the “exterior lights” broadly includes any exterior lighting on the vehicle. Such exterior lights may include headlamps (both low and high beam if separate from one another), tail lights, foul weather lights such as fog lights, brake lights, center-mounted stop lights (CHMSLs), turn signals, back-up lights, etc. The exterior lights may be operated in several different modes including conventional low-beam and high-beam states. They may also be operated as daytime running lights, and additionally as super-bright high beams in those countries where they are permitted.

The exterior light brightness may also be continuously varied between the low, high, and super-high states. Separate lights may be provided for obtaining each of these exterior lighting states or the actual brightness of the exterior lights may be varied to provide these different exterior lighting states. In either case, the “perceived brightness” or illumination pattern of the exterior lights is varied. As used herein, the term “perceived brightness” means the brightness of the exterior lights as perceived by an observer outside the vehicle. Most typically, such observers will be drivers or passengers in a preceding vehicle or in a vehicle traveling along the same street in the opposite direction. Ideally, the exterior lights are controlled such that if an observer is located in a vehicle within a “glare area” relative to the vehicle (i.e., the area in which the observer would perceive the brightness of the exterior lights as causing excessive glare), the beam illumination pattern is varied such that the observer is no longer in the glare area. The perceived brightness and/or glare area of the exterior lights may be varied by changing the illumination output of one or more exterior lights, by steering one or more lights to change the aim of one or more of the exterior lights, selectively blocking or otherwise activating or deactivating some or all of the exterior lights, altering the illumination pattern forward of the vehicle, or a combination of the above.

Imager 20 may be any conventional imager. Examples of suitable imagers are disclosed in published United States Patent Publication Nos. US 20080192132 A1 and US 20120072080 A1, and in U.S. Provisional Application Nos. 61/500,418 entitled “MEDIAN FILTER” filed on Jun. 23, 2011, by Jon H. Bechtel et al.; 61/544,315 entitled “MEDIAN FILTER” and filed on Oct. 7, 2011, by Jon H. Bechtel et al.; and 61/556,864 entitled “HIGH DYNAMIC RANGE CAMERA LOW LIGHT LEVEL FILTERING” filed on Nov. 8, 2011, by Jon H. Bechtel et al., the entire disclosures of which are incorporated herein by reference.

The imager 20 can include an image sensor (e.g. image sensor 201) or camera to capture images that may then be displayed and/or analyzed in order to control vehicle equipment in addition to exterior lights. For example, such imagers have been used for lane departure warning systems, forward collision warning systems, adaptive cruise control systems, pedestrian detection systems, night vision systems, terrain detection systems, parking assist systems, traffic sign recognition systems, and reverse camera display systems. Examples of systems using imagers for such purposes are disclosed in U.S. Pat. Nos. 5,837,994, 5,990,469, 6,008,486, 6,049,171, 6,130,421, 6,130,448, 6,166,698, 6,379,013, 6,403,942, 6,587,573, 6,611,610, 6,631,316, 6,774,988, 6,861,809, 7,321,112, 7,417,221, 7,565,006, 7,567,291, 7,653,215, 7,683,326, 7,881,839, 8,045,760, and 8,120,652, and in U.S. Provisional Application Nos. 61/512,213 entitled “RAISED LANE MARKER DETECTION SYSTEM AND METHOD THEREOF” and filed on Jul. 27, 2011, by Brock R. Rycenga et al., and 61/512,158 entitled “COLLISION WARNING SYSTEM AND METHOD THEREOF” and filed on Jul. 27, 2011, by Brock R. Rycenga et al., the entire disclosures of which are incorporated herein by reference.

In the example shown in FIG. 1, imager 20 may be controlled by controller 30. Communication of imager parameters as well as image data occurs over communication bus 40, which may be a bi-directional serial bus, parallel bus, a combination of both, or other suitable means. In one embodiment, controller 30 serves to perform equipment control functions by analyzing images from imager 20, determining an equipment state based upon information detected within those images, and communicating the determined equipment state to the equipment 50, equipment control 60, or exterior light control 70 through bus 42, which may be the vehicle bus 25, a CAN bus, a LIN bus or any other suitable communication link.

Controller 30 may control the imager 20 to be activated in several different modes with different exposure times and different readout windows. Controller 30 may be used to both perform the equipment control function and control the parameters of imager 20.

Controller 30 can also take advantage of the availability of signals (such as vehicle speed, windshield wiper speed, and outside temperature communicated via discreet connections or over the vehicle bus 25 in making decisions regarding the operation of the exterior lights 80. In particular, speed input 21 provides vehicle speed information to the controller 30 from which speed can be a factor in determining the control state for the exterior lights 80 or other equipment. The wiper speed input 22 informs controller 30 of the speed of operation of the windshield wipers, which may indicate the presence of snow or rain as opposed to fog. Exterior temperature (Ext. Temp.) input 23 provides an indication of the outside temperature. Manual dimmer switch input 24 is connected to a manually actuated switch (not shown) to provide a manual override signal for an exterior light control state. Some or all of the inputs 21, 22, 23, 24 and outputs 42a, 42b, and 42c, as well as any other possible inputs or outputs, such as a steering wheel input, can optionally be provided through vehicle bus 25 shown in FIG. 1. Alternatively, these inputs 21-24 may be provided to equipment control 60 and/or exterior light control 70.

Controller 30 can control, at least in part, other equipment 50 within the vehicle which is connected to controller 30 via vehicle bus 42. Specifically, the following are some examples of one or more equipment 50 that may be controlled by controller 30: exterior lights 80, a rain sensor, a compass, information displays, windshield wipers, a heater, a defroster, a defogger, an air conditioning system, a telephone system, a navigation system, a security system, a tire pressure monitoring system, a garage door opening transmitter, a remote keyless entry system, a telematics system, a voice recognition system such as a digital signal processor based voice actuation system, a vehicle speed control, interior lights, rearview mirrors, an audio system, an engine control system, and various other switches and other display devices that may be located throughout the vehicle.

In addition, controller 30 may be, at least in part, located within a rearview assembly of a vehicle or located elsewhere within the vehicle. The controller 30 may also use a second controller (or controllers), equipment control 60, which may be located in a rearview assembly or elsewhere in the vehicle in order to control certain kinds of equipment 62. Equipment control 60 can be connected to receive via vehicle bus 42 signals generated by controller 30. Equipment control 60 subsequently communicates and controls equipment 62 via bus 61. For example, equipment control 60 may be a windshield wiper control unit, which controls windshield wiper equipment, turning this equipment ON or OFF. Equipment control 60 may also be an electrochromic mirror control unit where controller 30 is programmed to communicate with the electrochromic control unit in order for the electrochromic control unit to change the reflectivity of the electrochromic mirror(s) in response to information obtained from an ambient light sensor, a glare sensor, as well as any other components coupled to the processor. Specifically, equipment control unit 60 in communication with controller 30 may control the following equipment: exterior lights, a rain sensor, a compass, information displays, windshield wipers, a heater, a defroster, a defogger, air conditioning, a telephone system, a navigation system, a security system, a tire pressure monitoring system, a garage door opening transmitter, a remote keyless entry, a telemetry system, a voice recognition system such as a digital signal processor-based voice actuation systems, a vehicle speed, interior lights, rearview mirrors, an audio system, a climate control, an engine control, and various other switches and other display devices that may be located throughout the vehicle.

Portions of imaging system 10 can be advantageously integrated into a rearview assembly 200 as illustrated in FIG. 2, wherein imager 20 is integrated into a mount 203 of rearview assembly 200. This location provides an unobstructed forward view through a region of the windshield 202 of the vehicle that is typically cleaned by the vehicle's windshield wipers (not shown). Additionally, mounting the image sensor 201 of imager 20 in the rearview assembly permits sharing of circuitry such as the power supply, microcontroller and light sensors.

Referring to FIG. 2, image sensor 201 is mounted within rearview mount 203, which is mounted to vehicle windshield 202. The rearview mount 203 provides an opaque enclosure for the image sensor 201 with the exception of an aperture through which light is received from a forward external scene.

Controller 30 of FIG. 1 may be provided on a main circuit board 215 and mounted in rearview housing 204 as shown in FIG. 2. As discussed above, controller 30 may be connected to imager 20 by a bus 40 or other means. The main circuit board 215 may be mounted within rearview housing 204 by conventional means. Power and a communication link 42 with the vehicle electrical system, including the exterior lights 80 (FIG. 1), are provided via a vehicle wiring harness 217 (FIG. 2).

Rearview assembly 200 may include a mirror element or a display that displays a rearward view. The mirror element may be a prismatic element or an electro-optic element, such as an electrochromic element.

Additional details of the manner by which imaging system 10 may be integrated into a rearview mirror assembly 200 are described in U.S. Pat. No. 6,611,610, the entire disclosure of which is incorporated herein by reference. Alternative rearview mirror assembly constructions used to implement imaging systems are disclosed in U.S. Pat. No. 6,587,573, the entire disclosure of which is incorporated herein by reference.

A method for detecting the presence of fog is described herein as being implemented by controller 30 using image data received from imager 20. This method may be a subroutine executed by any processor, and thus this method may be embodied in a non-transitory computer readable medium having stored thereon software instructions that, when executed by a processor, cause the processor to communicate with certain equipment of the controlled vehicle, by executing the steps of the method described below. In other words, aspects of the inventive method may be achieved by software stored on a non-transitory computer readable medium or software modifications or updates to existing software residing in a non-transitory computer readable medium. Such software or software updates may be downloaded into a first non-transitory computer readable media 500 of controller 30 (or locally associated with controller 30 or some other processor) typically prior to being installed in a vehicle, from a second non-transitory computer readable media 600 located remote from first non-transitory computer readable media 500. Second non-transitory computer readable media 600 may be in communication with first non-transitory computer readable media 500 by any suitable means, which may at least partially include the Internet or a local or wide area wired or wireless network.

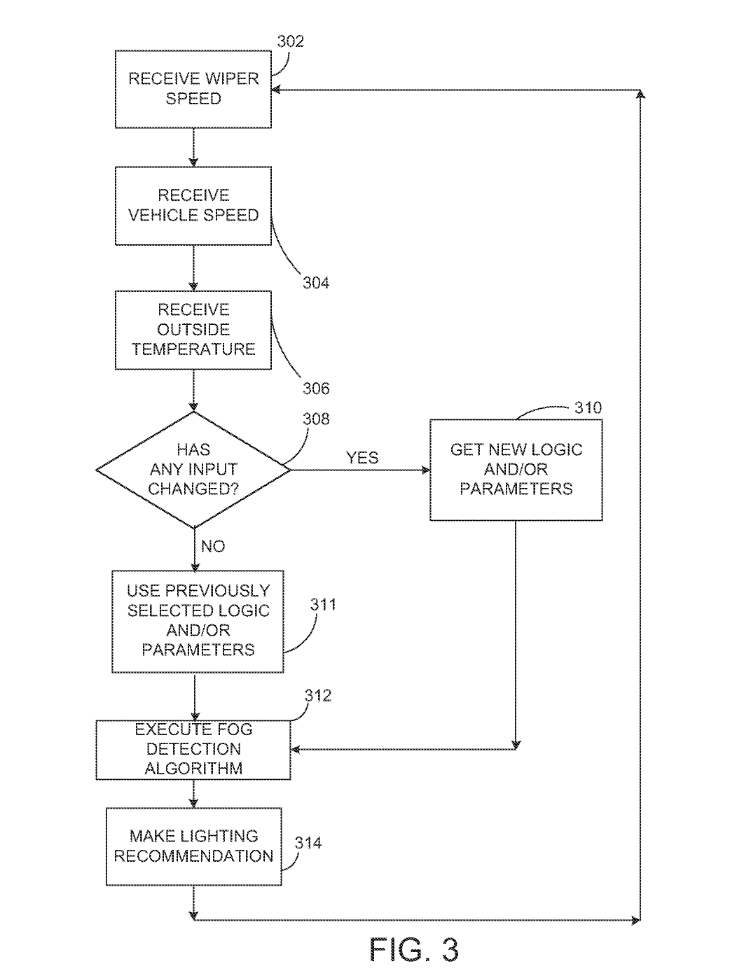

The method for controlling vehicle equipment of a controlled vehicle is described below with respect to FIGS. 1 and 3. FIG. 3 shows a flow chart illustrating one example of the method. The method includes receiving information including at least one of a windshield wiper speed (step 302), a vehicle speed (step 304), and an outside temperature (step 306). In step 308, controller 30 determines if any of these inputs have changed. If any of the inputs have changed, controller 30 selects logic and/or parameters from one or more tables for detecting the presence of fog in response to the changed input(s) in step 310 before proceeding to step 312. If the inputs have not changed, controller 30 uses previously selected logic and/or parameters in step 311 and proceeds to step 312.

In step 312, controller 30 executes a fog detection algorithm in which image data corresponding to the acquired images of the scene external and forward of the controlled vehicle is analyzed using the selected logic and/or parameters to detect the presence of fog. In this step, controller 30 may adjust a sensitivity to detected fog based on the received information inputs. For example, controller 30 may adjust the sensitivity to detected fog by being more sensitive when the outside temperature represents a temperature at which the presence of fog conditions is more likely and less sensitive when the outside temperature represents a temperature at which the presence of fog conditions is less likely. This would lower the possibility of wrongly mistaking the presence of fog from reflections from snow.

Subsequently, as shown in step 314, controller 30 generates a signal responsive to the detection of fog that can be used to control the vehicle equipment. In the example shown in FIG. 3, this signal may be a lighting recommendation used to control the exterior lights of a controlled vehicle. After execution of step 314, controller 30 returns to step 302 and continuously loops through the above steps.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An imaging system for detecting fog conditions surrounding a controlled vehicle, the system comprising:
an imager having an image sensor configured to image a scene external and forward of the controlled vehicle and to generate image data corresponding to the acquired images; and
a processor configured to:
receive the image data;
receive additional information including at least one of an outside temperature, a windshield wiper speed, and a vehicle speed;
select logic and/or parameters for detecting the presence of fog in response to the received additional information;
analyze the image data using the selected logic and/or parameters to detect the presence of fog; and
generate a signal responsive to the detection of fog.

2. The system of claim 1, wherein the processor adjusts a sensitivity to detected fog based on the received additional information.

3. The system of claim 2, wherein the processor adjusts the sensitivity to detected fog by being more sensitive when the outside temperature represents a temperature at which the presence of fog conditions is more likely and less sensitive when the outside temperature represents a temperature at which the presence of fog conditions is less likely.

4. The system of claim 1, wherein the signal is used as a recommendation for controlling an equipment of the controlled vehicle.

5. The system of claim 4, wherein the equipment comprises exterior lights of the controlled vehicle.

6. The system of claim 1, wherein the signal includes an indication of the detection of fog.

7. The system of claim 1, wherein the imager and the processor are integrated into a rearview assembly of the controlled vehicle.

8. A method for detecting fog conditions surrounding a controlled vehicle, comprising the steps of:
imaging a scene external and forward of the controlled vehicle and generating image data corresponding to the acquired images;
receiving additional information including at least one of an outside temperature, a windshield wiper speed, and a vehicle speed;
selecting logic and/or parameters for detecting the presence of fog in response to the received additional information;
analyzing the image data using the selected logic and/or parameters to detect the presence of fog; and
generating a signal responsive to the detection of fog.

9. The method of claim 8, further comprising the step of adjusting a sensitivity to detected fog based on the received additional information.

10. The method of claim 9, wherein the step of adjusting includes being more sensitive when the outside temperature represents a temperature at which the presence of fog conditions is more likely and less sensitive when the outside temperature represents a temperature at which the presence of fog conditions is less likely.

11. The method of claim 8, wherein the step of selecting includes getting newly selected logic and/or parameters if the additional information changes and using previously selected logic and/or parameters if the additional information is unchanged.

12. The method of claim 8, wherein the signal is used as a recommendation for controlling an equipment of the controlled vehicle.

13. The method of claim 12, wherein the equipment comprises exterior lights of the controlled vehicle.

14. The method of claim 8, wherein the signal includes an indication of the detection of fog.

15. A non-transitory computer readable medium having stored thereon software instructions executed by a processor, the software instructions comprising the steps of:
imaging a scene external and forward of the controlled vehicle and generating image data corresponding to the acquired images;
receiving additional information including at least one of an outside temperature, a windshield wiper speed, and a vehicle speed;
selecting logic and/or parameters for detecting the presence of fog in response to the received additional information;
analyzing the image data using the selected logic and/or parameters to detect the presence of fog; and
generating a signal responsive to the detection of fog.

16. The non-transitory computer readable medium of claim 15, wherein the software instructions further comprise the step of adjusting a sensitivity to detected fog based on the received additional information.

17. The non-transitory computer readable medium of claim 16, wherein the step of adjusting includes being more sensitive when the outside temperature represents a temperature at which the presence of fog conditions is more likely and less sensitive when the outside temperature represents a temperature at which the presence of fog conditions is less likely.

18. The non-transitory computer readable medium of claim 15, wherein the signal is used as a recommendation for controlling an equipment of the controlled vehicle.

19. The non-transitory computer readable medium of claim 18, wherein the equipment comprises exterior lights of the controlled vehicle.

20. The non-transitory computer readable medium of claim 15, wherein the signal includes an indication of the detection of fog.
